(19) United States
(12) Patent Application Publication
(10) Pub. No.: US 2015/0172064 A1
(43) Pub. Date: Jun. 18, 2015

(54) METHOD AND RELAY DEVICE FOR CRYPTOGRAPHIC COMMUNICATION

(71) Applicant: FUJITSU LIMITED, Kawasaki-shi (JP)

(72) Inventors: Masahiko TAKENAKA, Kawasaki (JP); Daisuke Shinomiya, Kawasaki (JP); Hideki Ise, Hachioji (JP)

(21) Appl. No.: 14/557,034

(22) Filed: Dec. 1, 2014

(30) Foreign Application Priority Data
Dec. 13, 2013 (JP) 2013-258615

(51) Int. Cl. H04L 9/32

(52) U.S. Cl. CPC H04L 9/3268

(57) ABSTRACT

A communication method is used in a relay device that is provided between a terminal and a server. The communication method includes: verifying a reliability of a server certificate that is transmitted from the server for cryptographic communication between the server and the relay device using a processor; issuing a proxy certificate based on the reliability of the server certificate for cryptographic communication between the relay device and the terminal using the processor; and transmitting the proxy certificate to the terminal.

### CROSS-REFERENCE TO RELATED APPLICATION

This application is based upon and claims the benefit of priority of the prior Japanese Patent Application No. 2013-258615, filed on Dec. 13, 2013, the entire contents of which are incorporated herein by reference.

### FIELD

The embodiments discussed herein are related to a method and a relay device for cryptographic communication.

### BACKGROUND

A configuration is put into practical use in which a relay device is provided between an intranet and the internet so as to provide high-speed access and secure communication. The relay device as described above is realized, for example, by a proxy server. As an example, an HTTP proxy server is known.

When a terminal in an intranet accesses a Web server on the internet, the proxy server relays communications between them. In other words, the proxy server operates on behalf of the Web server with respect to the terminal, and operates on behalf of the terminal with respect to the Web server. At this time, communication between the terminal and the Web server is temporarily terminated in the proxy server. This allows the proxy server to provide various services for communication between the terminal and the Web server. For example, the proxy server can provide the terminal with high-speed communication by storing communication data in a cache. In addition, the proxy server can perform a virus check and access restriction by verifying communication contents. For example, in an enterprise network, communication contents are often verified using the proxy server. The proxy server is installed in, for example, a dedicated computer that provides a proxy service. Alternatively, the proxy server may be installed in firewall equipment, Unified Threat Management (UTM) device, or the like.

SSL (Secure Sockets Layer) is widely put into practical use as one of cryptographic protocols that are used in commercial transactions via the internet or inter-cite communication. In addition, TLS (Transport Layer Security) is becoming increasingly used as a successor protocol to SSL. Therefore, when SSL or TLS is used between the terminal and the Web server, secure communication is guaranteed. In the description below, it is assumed that “SSL” includes TLS.

In the above situations, SSL is sometimes applied to communication via the proxy server. In this case, an SSL function is installed in the proxy server. Hereinafter, a proxy server with an SSL function is sometimes referred to as an “SSL proxy server”.

However, because SSL provides cryptographic communication in a peer-to-peer mode, the SSL proxy server sometimes does not terminate communication between the terminal and the Web server. In this case, the SSL proxy server is not capable of verifying the communication contents, and, for example, confidential information is sometimes transmitted intentionally or negligently to the outside.

In order to address the above problem, a method for terminating SSL communication in the proxy server is proposed. In this method, SSL communication paths are configured respectively between the Web server and the proxy server and between the proxy server and the terminal. In addition, the proxy server terminates each of the SSL communication paths. Therefore, even when cryptographic communication is performed between the Web server and the terminal, the proxy server can verify the communication contents, and can interrupt the communication if needed.

As a related technology, a cryptographic communication system is proposed that enables direct authentication between a client and a server when the client and the server perform cryptographic communication using different sessions via a relay computer (for example, Japanese Laid-open Patent Publication No. 2003-124926). In addition, a relay server is proposed that performs verification instead of a portable information processing device, and that reports the verification result to the portable information processing device (for example, Japanese Laid-open Patent Publication No. 2009-60244).

When SSL communication is performed between the terminal and the Web server, a certificate authority issues a certificate that authenticates the Web server, and the certificate is transmitted from the Web server to the terminal. However, in a communication system in which SSL communication is terminated in the proxy server, the proxy server issues a new certificate, and transmits the new certificate to the terminal. Therefore, when the certificate issued by the proxy server has a high reliability for the terminal, the terminal starts SSL communication regardless of whether the certificate that authenticates the Web server is reliable. In other words, in this case, the terminal may perform communication with an unreliable Web server, which causes a security problem.

The above problem may be solved, for example, by deciding the reliability of the certificate that authenticates the Web server in the proxy server. In this case, when it is decided that the reliability of the certificate that authenticates the Web server is low, the proxy server interrupts communication between the terminal and the Web server. However, a user of the terminal sometimes wishes to perform communication even if the communication is related to an unreliable certificate. For example, a certificate sometimes is not issued by a reliable certificate authority to a maintenance port of communication equipment. In this case, when the terminal accesses the maintenance port of the communication equipment via the proxy server, communication is interrupted by the proxy server. In other words, in this method, convenience is likely to be reduced.

As described above, it is difficult to satisfy both security and convenience in cryptographic communication (in the above example, SSL communication) via a relay device (in the above example, a proxy server).

### SUMMARY

According to an aspect of the embodiments, a communication method, used in a relay device that is provided between a terminal and a server, includes: verifying a reliability of a server certificate that is transmitted from the server for cryptographic communication between the server and the relay device using a processor; issuing a proxy certificate based on the reliability of the server certificate for cryptographic communication between the relay device and the terminal using the processor; and transmitting the proxy certificate to the terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a sequence of a communication method according to an embodiment.

FIG. 2 illustrates an example of a server certificate.

FIGS. 3A-3C illustrate examples of a server certificate and a proxy certificate.

FIG. 4 is a block diagram that illustrates a function of an SSL proxy server.

FIG. 5 is a flowchart illustrating an example of a process of issuing a certificate.

FIG. 6 is a flowchart illustrating another example of the process of issuing a certificate.

FIG. 7 is a flowchart illustrating still another example of the process of issuing a certificate.

FIG. 8 illustrates a hardware configuration of a relay device.

### DESCRIPTION OF EMBODIMENTS

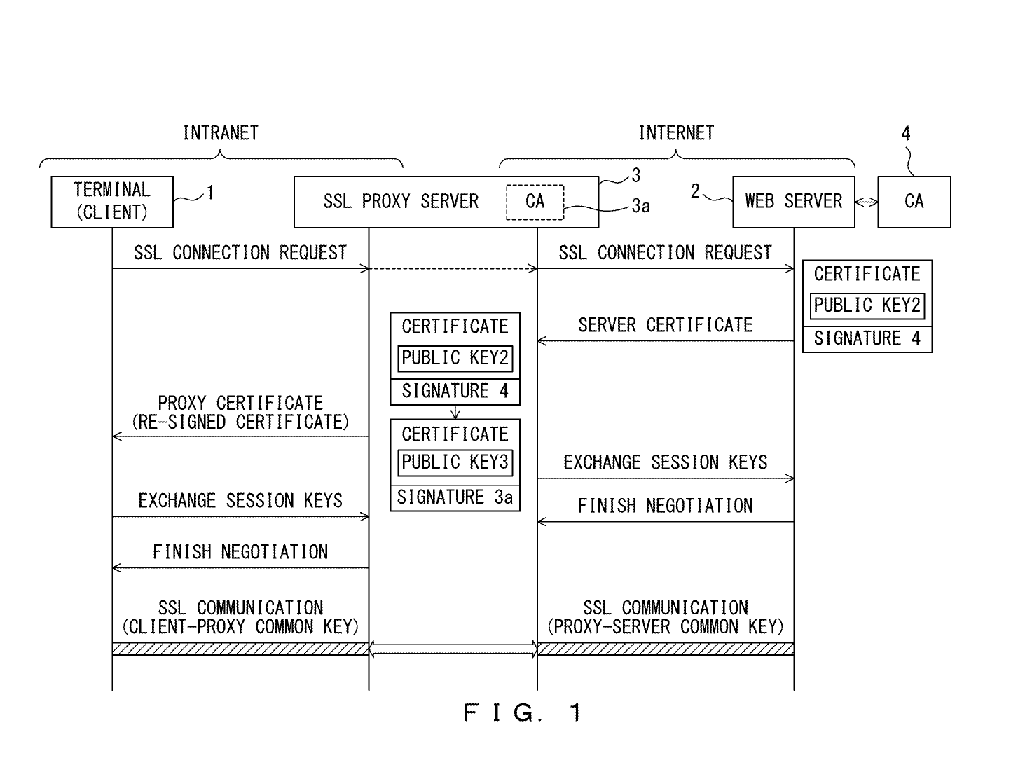

FIG. 1 illustrates a sequence of a communication method according to an embodiment. This communication method includes a procedure of confirming the reliability of a server, and a procedure of exchanging keys for cryptographic communication. A cryptographic protocol is SSL in this specification. Assume that SSL includes TLS.

In the description below, it is assumed that a terminal (client) 1 in an intranet accesses a Web server 2 on the internet. A Web browser is, for example, installed in the terminal 1. In addition, an SSL proxy server 3 is provided at a boundary between the intranet and the internet. In other words, the SSL proxy server 3 is provided between the terminal 1 and the Web server 2. The SSL proxy server 3 is an example of a relay device that relays data between the terminal 1 and the Web server 2.

The terminal 1, the Web server 2, and the SSL proxy server 3 are each installed with a program needed for performing SSL communication. Therefore, the terminal 1 and the Web server 2 can perform cryptographic communication using SSL. The SSL proxy server 3 can terminate an SSL communication path between the terminal 1 and the Web server 2. In other words, SSL communication between the terminal 1 and the Web server 2 is implemented by SSL communication between the terminal 1 and the SSL proxy server 3 and SSL communication between the SSL proxy server 3 and the Web server 2.

A Certificate Authority (CA) 4 is an organization that issues an electronic certificate or a digital certificate (hereinafter referred to as a “certificate”). In the example illustrated in FIG. 1, the Web server 2 requests the certificate authority 4 to issue a server certificate. At this time, the certificate authority 4 verifies whether the certificate authority 4 authenticates the Web server 2. When the certificate authority 4 authenticates the Web server 2, the certificate authority 4 issues a server certificate that certifies the right to use a domain name of the Web server 2.

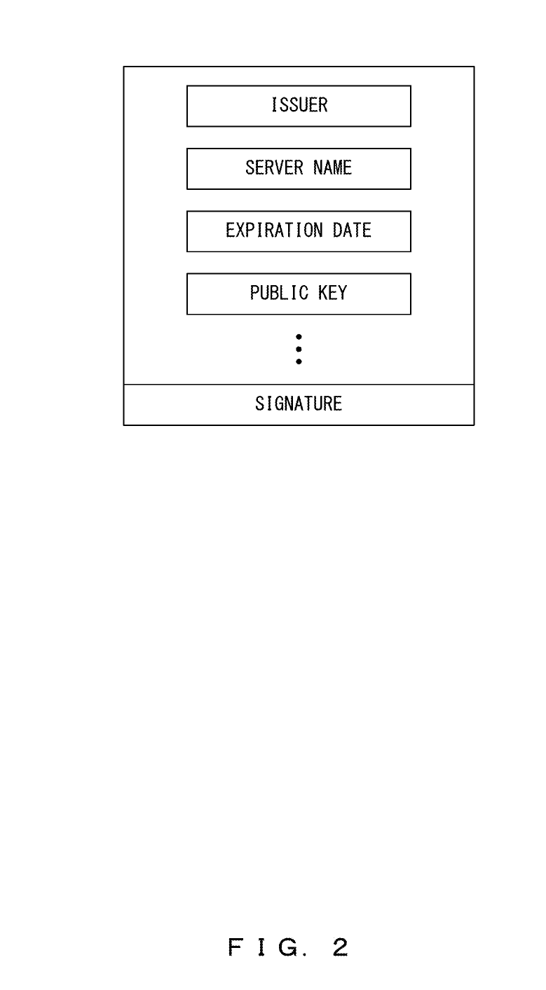

The server certificate includes an issuer, a server name, an expiration date, and a public key, as illustrated in FIG. 2, for example. The “issuer” identifies a certificate authority that issues the server certificate (in FIG. 1, the certificate authority 4). The “server name” indicates a name of a Web server (e.g., a domain name of the Web server) that is authenticated by the certificate authority. The “expiration date” indicates an expiration date of the server certificate. The “public key” is a public key that the Web server uses in order to perform SSL communication. The public key may be set in the server certificate when the Web server transmits the server certificate to a client. Note that the Web server stores a private key corresponding to the public key.

A “signature” is given to the server certificate. The “signature” is generated by encrypting a hash value of the contents of the server certificate using a signature private key of the certificate authority 4. In the description below, generating signature data corresponding to a certificate and giving the signature data to the certificate may be referred to as “sign” or “signing”. A server certificate to which the signature data has been given may be referred to as a “server certificate”.

Assume that, in a network system having the above configuration, the terminal 1 accesses the Web server 2. In this case, the terminal 1 transmits an SSL connection request to the Web server 2. The SSL connection request is first received by the SSL proxy server 3. Then, the SSL proxy server 3 transfers the SSL connection request to the Web server 2.

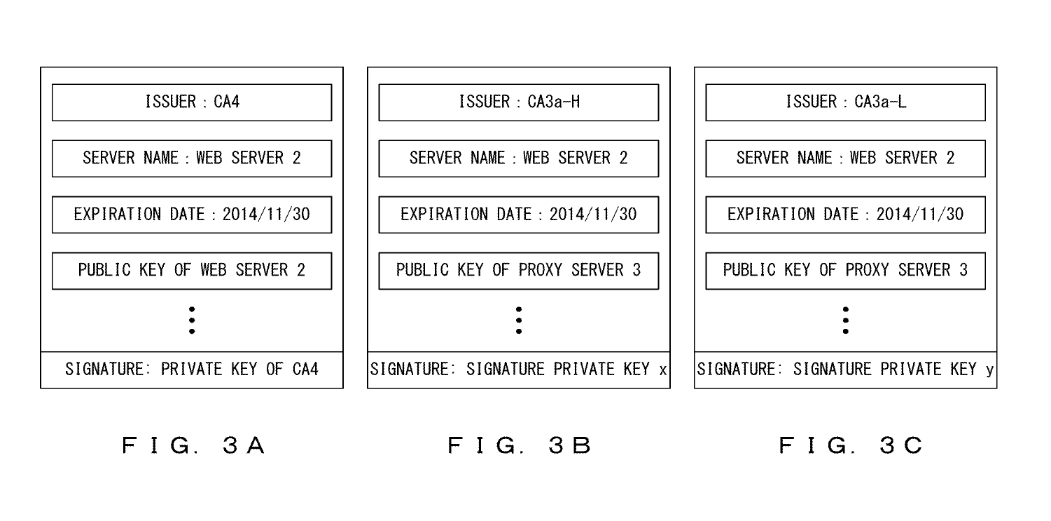

The Web server 2 returns the server certificate in response to the received SSL connection request. An example of the server certificate that is transmitted from the Web server 2 to the SSL proxy server 3 is illustrated in FIG. 3A.

In the server certificate transmitted from the Web server 2, the issuer is the “certificate authority 4”. The server name is a domain name of the Web server 2. The expiration date is Nov. 30, 2014 in this example. The public key is a public key of the Web server 2. The signature data is obtained by encrypting the contents of the server certificate using a signature private key of the certificate authority 4.

In FIG. 1, “public key 2” in the server certificate indicates the public key of the Web server 2. In addition, “signature 4” given to the server certificate indicates that the signature data is generated using the private key of the certificate authority 4.

As described above, the server certificate and the signature data are transmitted from the Web server 2 to the SSL proxy server 3. In other words, the server certificate that has been signed using the private key of the certificate authority 4 is transmitted from the Web server 2 to the SSL proxy server 3. At this time, the signature data is a ciphertext, but the server certificate is a plaintext.

The SSL proxy server 3 provides a proxy function and a certificate authority function for communication between the terminal 1 and the Web server 2. In other words, the SSL proxy server 3 operates on behalf of the Web server 2 with respect to the terminal 1, and operates on behalf of the terminal 1 with respect to the Web server 2. In addition, the SSL proxy server 3 includes a private certificate authority 3a, and can operate as a certificate authority within an intranet.

Therefore, when the SSL proxy server 3 receives the server certificate from the Web server 2, the SSL proxy server issues a proxy certificate according to the server certificate. At this time, the SSL proxy server 3 may generate the proxy certificate by updating the “issuer” and the “public key” in the received server certificate. In this case, the “issuer” is changed from “certificate authority 4” to “private certificate authority 3a”. In addition, the “public key” is changed from “public key of Web server 2” to “public key of SSL proxy server 3”.

In addition, the SSL proxy server 3 signs the proxy certificate. At this time, the private certificate authority 3a generates proxy signature data by encrypting a hash value of the contents of the proxy certificate using a signature private key of the private certificate authority 3a. Then, the SSL proxy server 3 transmits the proxy certificate and the proxy signature data to the terminal 1. In other words, the proxy certificate signed by the private certificate authority 3a (a re-signed certificate) is transmitted from the SSL proxy server 3 to the terminal 1. Also in this case, the proxy signature data is a ciphertext, but the proxy certificate is a plaintext.

In FIG. 1, “public key 3” in the proxy certificate indicates a public key of the SSL proxy server 3. In addition, “signature 3a” given to the proxy certificate indicates that the proxy signature data is generated using the private key of the private certificate authority 3a of the SSL proxy server 3.

When the terminal 1 receives the proxy certificate from the SSL proxy server 3, the terminal 1 verifies the reliability of the proxy certificate. Here, assume that the terminal 1 has a certificate authority list in which reliable certificate authorities have been registered. In this case, the terminal 1 decides whether an “issuer” described in the received proxy certificate has been registered in the certificate authority list. When the “issuer” described in the received proxy certificate has been registered in the certificate authority list, the terminal 1 decides that the proxy certificate has a high reliability.

In addition, the terminal 1 verifies that the received proxy certificate has not been falsified. In other words, the terminal 1 calculates a hash value of the received proxy certificate. In addition, the terminal 1 decrypts the proxy signature data using a signature public key corresponding to the signature private key of the private certificate authority 3a. When the hash value of the proxy certificate matches the decryption result of the proxy signature data, the terminal 1 decides that the proxy certificate has not been falsified.

When the proxy certificate has a high reliability and the proxy certificate has not been falsified, the terminal 1 exchanges session keys with the SSL proxy server 3. At this time, the terminal 1 generates, for example, a common key, encrypts the common key using the public key obtained from the proxy certificate (i.e., the public key of the SSL proxy server 3), and transmits the encrypted common key to the SSL proxy server 3. Then, the SSL proxy server 3 decrypts the ciphertext using the private key of the SSL proxy server 3, and obtains the common key. As a result, the terminal 1 and the SSL proxy server 3 can obtain a key for encrypting data in the SSL communication (a client-proxy common key). Then, a negotiation finishing process is performed.

A process of exchanging session keys is similarly performed between the SSL proxy server 3 and the Web server 2. As a result, the SSL proxy server 3 and the Web server 2 can obtain a key for encrypting data in the SSL communication (a proxy-Web server common key).

After the processes above, the terminal 1 can access the Web server 2 in the SSL communication. Between the terminal 1 and the SSL proxy server 3, an SSL communication path that uses the client-proxy common key is configured. In addition, between the SSL proxy server 3 and the Web server 2, an SSL communication path that uses the proxy-Web server common key is configured.

In the network system having the above configuration, the SSL proxy server 3 verifies the reliability of the server certificate. Then, the SSL proxy server 3 can issue a proxy certificate corresponding to the verification result. In other words, the SSL proxy server 3 can issue a proxy certificate corresponding to the reliability of the server certificate. At this time, the SSL proxy server 3 can sign the proxy certificate using the key corresponding to the reliability of the server certificate.

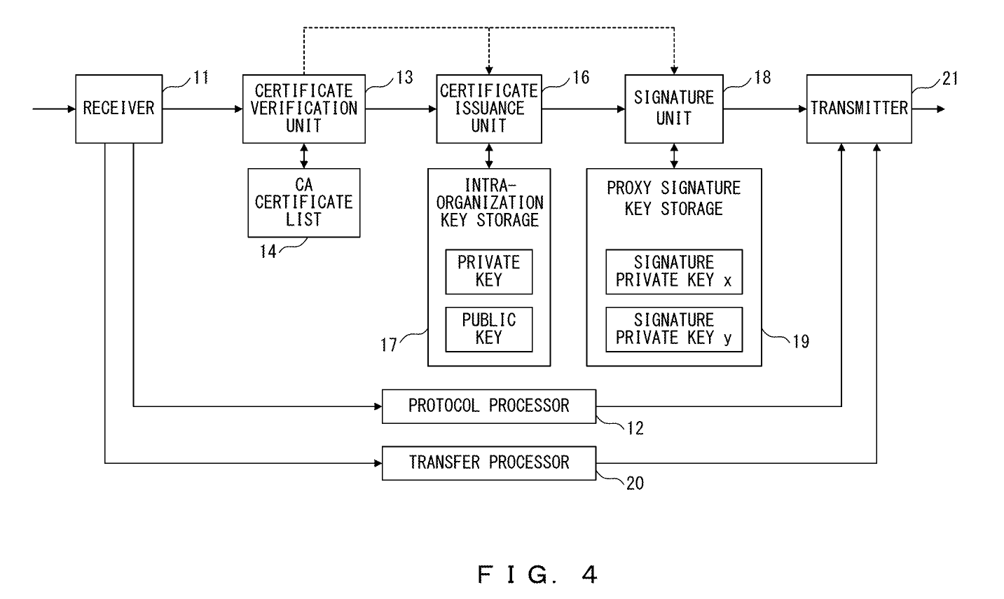

FIG. 4 is a block diagram that illustrates a function of the SSL proxy server 3. In this example, as illustrated in FIG. 4, the SSL proxy server 3 includes a receiver 11, a protocol processor 12, a certificate verification unit 13, a CA certificate list 14, a certificate issuance unit 16, an intra-organization key storage 17, a signature unit 18, a proxy signature key storage 19, a transfer processor 20, and a transmitter 21. However, the SSL proxy server 3 may include other functional elements.

The receiver 11 terminates a received signal, and detects the contents of the received signal. When an SSL protocol message is detected from the received signal, the receiver 11 extracts the SSL protocol message from the received signal, and guides the SSL protocol message to the protocol processor 12. When a server certificate is detected from the received signal, the receiver 11 extracts the server certificate from the received signal, and guides the server certificate to the certificate verification unit 13. When the receiver 11 receives a data frame or a data packet, the receiver 11 directs the data frame or the data packet to the transfer processor 20.

The protocol processor 12 performs a process relating to an SSL protocol. In the sequence illustrated in FIG. 1, for example, when the protocol processor 12 receives an SSL connection request message from the terminal 1, the protocol processor 12 transfers the SSL connection request message to the Web server 2. At this time, the protocol processor 12 may call the certificate verification unit 13, the certificate issuance unit 16, and the signature unit 18 if needed.

The certificate verification unit 13 verifies the reliability of the received certificate. In the sequence illustrated in FIG. 1, for example, the certificate verification unit 13 verifies the reliability of the server certificate transmitted from the Web server 2. In one example, the certificate verification unit 13 refers to the CA certificate list 14, and decides whether the received server certificate satisfies specified conditions concerning the reliability of the server certificate.

In the CA certificate list 14, CA certificates have been registered that were issued from certificate authorities that the SSL proxy server 3 can rely on. The “certificate authorities that the SSL proxy server 3 can rely on” are determined by, for example, a network administrator who manages the SSL proxy server 3. Each of the CA certificates registered in the CA certificate list 14 includes a server signature public key. The server signature public key corresponds to a server signature private key used for the signature of the server certificate. The server signature public key is obtained by, for example, the network administrator who manages the SSL proxy server 3.

The certificate verification unit 13 verifies the reliability of the server certificate, for example, by deciding whether the received server certificate satisfies the following three conditions.

(1) An issuer of a server certificate matches an issuer of one of the CA certificates registered in the CA certificate list 14.
(2) A hash value of a server certificate matches a decryption result of signature data.
(3) An expiration date of a server certificate has not expired.
In the example illustrated in FIG. 1, for example, the issuer of the server certificate is the certificate authority 4. Therefore, when the CA certificate issued by the certificate authority 4 has been registered in the CA certificate list 14, it is decided that the server certificate satisfies condition (1). On the other hand, when the CA certificate issued by the certificate authority 4 has not been registered in the CA certificate list 14, the certificate verification unit 13 decides that the server certificate received from the Web server is not reliable. In addition, the signature data of the server certificate is decrypted using the server signature public key that is included in the CA certificate registered in the CA certificate list 14. Then, when the decryption result matches the hash value of the server certificate, it is decided that the server certificate satisfies condition (2). On the other hand, when the decryption result does not match the hash value of the server certificate, the certificate verification unit 13 decides that the server certificate may have been falsified.

When the server certificate satisfies all of conditions (1) to (3), the certificate verification unit 13 decides that the received server certificate is reliable. On the other hand, when the server certificate does not satisfy at least one of conditions (1) to (3), the certificate verification unit 13 decides that the received server certificate is not reliable. Then, the certificate verification unit 13 reports the decision result to the certificate issuance unit 16 and the signature unit 18.

The certificate issuance unit 16 issues a proxy certificate in accordance with the verification result by the certificate verification unit 13. In other words, the certificate issuance unit 16 issues a proxy certificate in accordance with the reliability of the received server certificate (in this example, whether the received server certificate is reliable).

The intra-organization key storage 17 stores a set of a private key and a public key used in the SSL communication within the organization. In other words, the intra-organization key storage 17 stores a set of a private key and a public key used in SSL communication within an intranet. The intra-organization key storage 17 may store a plurality of sets of private key and public key.

The certificate issuance unit 16 may generate a proxy certificate, for example, from the received server certificate. As an example, described is a procedure of generating a proxy certificate from the server certificate illustrated in FIG. 3A.

When it is decided that the received server certificate is reliable, the certificate issuance unit 16 rewrites an issuer from “CA4” to “CA3a-H”. “CA3a” indicates the private certificate authority 3a of the SSL proxy server 3. “H” indicates that a server certificate has a high reliability. Therefore, “CA3a-H” indicates that “the private certificate authority 3a decides that the server certificate has a high reliability”. In addition, the certificate issuance unit 16 replaces “public key of the Web server 2” with “public key of the proxy server 3”. The public key of the proxy server 3 corresponds to a public key of a set of private key and public key that has been stored in the intra-organization key storage 17. As a result, the proxy certificate illustrated in FIG. 3B (a high-reliability proxy certificate) is generated.

On the other hand, when it is decided that the received server certificate is not reliable, the certificate issuance unit 16 rewrites the issuer from “CA4” to “CA3a-L”. “L” indicates that a server certificate has a low reliability. Therefore, “CA3a-L” indicates that “the private certificate authority 3a decides that the server certificate has a low reliability”. In addition, the certificate issuance unit 16 replaces “public key of the Web server 2” with “public key of the proxy server 3” similarly to a case in which the received server certificate is reliable. As a result, the proxy certificate illustrated in FIG. 3C (a low-reliability proxy certificate) is generated.

As described above, the certificate issuance unit 16 issues a proxy certificate (a high-reliability proxy certificate or a low-reliability proxy certificate) according to the reliability of the received server certificate (in this example, whether the received server certificate is reliable). The other information elements in the certificate may be changed or not changed as needed. In addition, the certificate issuance unit 16 can add desired information when the proxy certificate is generated from the server certificate.

The signature unit 18 signs the proxy certificate generated by the certificate issuance unit 16. The “sign” or “signing” is realized by generating proxy signature data corresponding to the proxy certificate. The proxy signature data is generated by encrypting a hash value of the contents of the proxy certificate using the signature private key of the private certificate authority 3a in the SSL proxy server 3. Note that the signature unit 18 generates the proxy signature data using a signature private key corresponding to the reliability of the received server certificate (in this example, whether the received server certificate is reliable). The proxy signature key storage 19 stores signature private keys used by the signature unit 18. In this example, the proxy signature key storage 19 stores a plurality of signature private keys x, y, and so on.

When it is decided that the received server certificate is reliable, the signature unit 18 generates the proxy signature data using the signature private key x. As a result, the re-signed certificate illustrated in FIG. 3B (a proxy certificate and proxy signature data) is obtained. In contrast, when it is decided that the received server certificate is not reliable, the signature unit 18 generates proxy signature data using the signature private key y. In this case, the re-signed certificate illustrated in FIG. 3C is obtained.

The transfer processor 20 guides a received data frame and a received data packet to the transmitter 21. At this time, the transfer processor 20 may update the contents of the received data frame and the received data packet.

When the transmitter 21 receives an SSL protocol message from the protocol processor 12, the transmitter 21 transmits the SSL protocol message to a specified destination. In addition, the transmitter 21 transmits the re-signed certificate to the destination. At this time, the transmitter 21 transmits, to the destination, the proxy certificate generated by the certificate issuance unit 16 and the proxy signature data generated by the signature unit 18. In addition, the transmitter 21 transmits, to a specified destination, the data frame or the data packet processed by the transfer processor 20.

The re-signed certificate transmitted from the SSL proxy server 3 is received by the terminal 1. Then, the terminal 1 verifies the re-signed certificate. Assume that the terminal 1 stores signature public keys X and Y corresponding to the signature private keys x and y that are generated in the SSL proxy server 3. The signature public keys X and Y are included in, for example, the CA certificate issued by the private certificate authority CA3a and stored by the terminal 1.

The terminal 1 can decide the reliability of the server certificate that authenticates the Web server 2 in accordance with the “issuer” of the received re-signed certificate. In this example, when “issuer: CA3a-H” is obtained, the terminal 1 decides that the server certificate that authenticates the Web server 2 has a high reliability. In contrast, when “issuer: CA3a-L” is obtained, the terminal 1 decides that the server certificate that authenticates the Web server 2 has a low reliability. As described above, the terminal 1 can confirm the reliability of the server certificate that authenticates the Web server 2 in accordance with the re-signed certificate received from the SSL proxy server 3.

In addition, the terminal 1 can confirm whether the received re-signed certificate has been falsified. In other words, when the server certificate has a high reliability, the terminal 1 decrypts the re-signed certificate using the signature public key X that is included in the CA certificate of the private certificate authority, and compares the decryption result with a hash value of the re-signed certificate so as to decide whether the received re-signed certificate has been falsified. On the other hand, when the server certificate has a low reliability, the terminal 1 decrypts the re-signed certificate using the signature public key Y that is included in the CA certificate of the private certificate authority, and compares the decryption result with the hash value of the re-signed certificate so as to decide whether the received re-signed certificate has been falsified.

Alternatively, the terminal 1 may decrypt the re-signed certificate respectively using the signature public keys X and Y, which are included in the CA certificates of the private certificate authority. In this case, when the decryption result using the signature public key X matches the hash value of the re-signed certificate, the terminal 1 may decide that the server certificate that authenticates the Web server 2 has a high reliability. Alternatively, when the decryption result using the signature public key Y matches the hash value of the re-signed certificate, the terminal 1 may decide that the server certificate that authenticates the Web server 2 has a low reliability.

As described above, in a communication method according to the embodiment, when an SSL connection request is issued from the terminal 1, the SSL proxy server 3 issues a proxy certificate corresponding to the reliability of the server certificate, and transmits the proxy certificate to the terminal 1. Accordingly, following points (1) to (3) are realized.

(1) The SSL proxy server 3 issues a proxy certificate and transmits the proxy certificate to the terminal 1, even when the server certificate has a low reliability. Accordingly, even when the server certificate has a low reliability, communication between the terminal 1 and the Web server 2 is not interrupted by the SSL proxy server 3. Thus, a deterioration in convenience is prevented.
(2) The SSL proxy server 3 transmits, to the terminal 1, proxy certificates having contents that differ in accordance with the reliabilities of the server certificates. Accordingly, the terminal 1 can confirm the reliability of the server certificate by receiving the proxy certificate. Thus, a deterioration in security is prevented.
(3) The SSL proxy server 3 terminates the SSL communication path. Accordingly, the SSL proxy server 3 can monitor the contents of communication between the terminal 1 and the Web server 2. Thus, leakage of secret information, for example, within an intranet can be prevented.

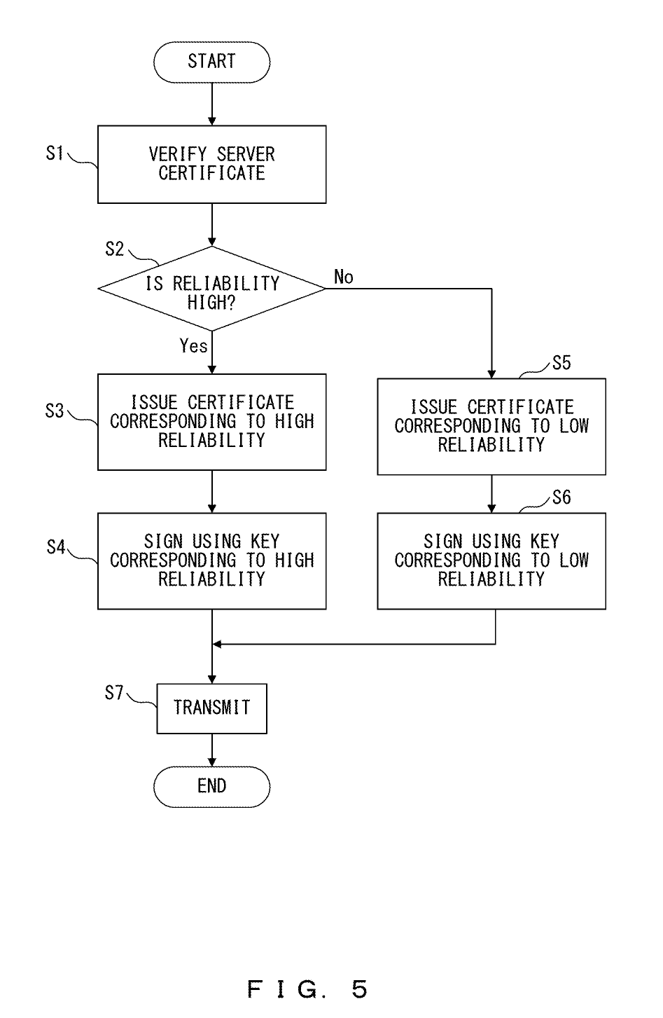

FIG. 5 is a flowchart illustrating a process of issuing a re-signed certificate in the SSL proxy server 3. This process is performed when a server certificate is transmitted by the Web server 2 in response to an SSL connection request, and the SSL proxy serve 3 receives the server certificate.

In S1 and S2, the certificate verification unit 13 verifies the reliability of the server certificate received from the Web server 2. In the example illustrated in FIG. 5, it is decided whether the server certificate has a high reliability or a low reliability. An example of the method for verifying the server certificate has been described above.

When it is decided that the server certificate has a high reliability, the certificate issuance unit 16 generates a proxy certificate corresponding to the high reliability. In this case, the certificate issuance unit 16 generates a proxy certificate including information indicating that the server certificate has a high reliability. In the example illustrated in FIG. 3B, “issuer: CA3a-H” is set as information indicating that the server certificate has a high reliability. Further, in S4, the signature unit 18 signs the proxy certificate generated in S3. At this time, the signature unit 18 signs the proxy certificate using a key corresponding to the high reliability. In the example illustrated in FIG. 3B, a hash value of the proxy certificate is encrypted using the signature private key x so as to generate proxy signature data.

When it is decided that the server certificate has a low reliability, the certificate issuance unit 16 generates a proxy certificate corresponding to a low reliability in S5. At this time, the certificate issuance unit 16 generates a proxy certificate including information indicating that the server certificate has a low reliability. In the example illustrated in FIG. 3C, “issuer: CA3a-L” is set as information indicating that the server certificate has a low reliability. Further, in S6, the signature unit 18 signs the proxy certificate generated in S5. At this time, the signature unit 18 signs the proxy certificate using a key corresponding to the low reliability. In the example illustrated in FIG. 3C, the hash value of the proxy certificate is encrypted using the signature private key y so as to generate proxy signature data.

In the proxy certificate generated in S3 or S5, a public key in the set of private key and public key used within an organization is set. Here, the certificate issuance unit 16 may set the same public key in the proxy certificate regardless of whether the server certificate has a high reliability or a low reliability.

In S7, the SSL proxy server 3 transmits, to the terminal 1, the proxy certificate and corresponding proxy signature data as described above. As a result, the terminal 1 receives a proxy certificate corresponding to the reliability of the server certificate.

In the above example, the certificate issuance unit 16 generates a proxy certificate according to a received server certificate; however, the invention is not limited to this method. As an example, the SSL proxy server 3 may store plural different proxy certificates (a certificate corresponding to a high reliability and a certificate corresponding to a low reliability). In this case, in each of the proxy certificates, a public key in the set of private key and public key used in the organization is set. Then, the SSL proxy server 3 selects a proxy certificate in accordance with the verification result with respect to the reliability of the server certificate, and transmits the selected proxy certificate to the terminal 1.

In addition, in the above example, a proxy certificate including information indicating the reliability of the server certificate is generated, and the proxy certificate is signed using the key corresponding to the reliability of the server certificate; however, the invention is not limited to this method. As an example, the SSL proxy server 3 may generate a proxy certificate including information indicating the reliability of the server certificate and may sign the proxy certificate using a key that is independent of the reliability of the server certificate.

Further, in the above example, the verification result of the server certificate is “high reliability” or “low reliability”; however, the invention is not limited to this method. As an example, the SSL proxy server 3 may issue a proxy certificate in accordance with a reason why the server certificate has a low reliability.

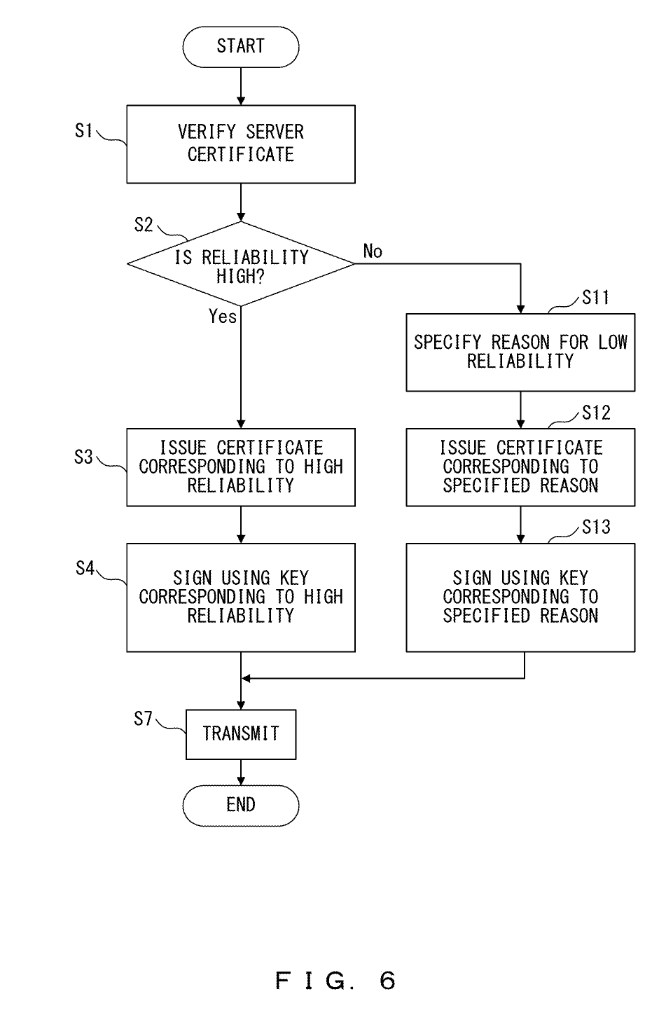

FIG. 6 is a flowchart illustrating a process of issuing a certificate in accordance with a reason why the server certificate has a low reliability. S1-S4 of FIG. 6 are substantially the same as those of FIG. 5, and descriptions thereof are omitted.

In the example illustrated in FIG. 6, when it is decided that the server certificate has a low reliability, the certificate verification unit 13 specifies, in S11, the reason why the server certificate has a low reliability. At this time, the certificate verification unit 13 decides whether the reason falls under, for example, any of the following three reasons.

(1) A certificate authority that has issued the server certificate is not reliable.
(2) An expiration date of the server certificate has expired.

### (3) Self-signature

Then, the certificate verification unit 13 reports the decision result to the certificate issuance unit 16 and the signature unit 18.

In S12, the certificate issuance unit 16 generates a proxy certificate including information corresponding to the reason why the server certificate has a low reliability. As an example, the certificate issuance unit 16 generates a proxy certificate in which information indicating the reason why the server certificate has a low reliability is set in the “issuer”. In S13, the signature unit 18 signs the proxy certificate generated in S12. At this time, the signature unit 18 signs the proxy certificate using a key corresponding to the reason why the server certificate has a low reliability.

According to this method, the terminal 1 can recognize the reason why the server certificate that authenticates the Web server 2 has a low reliability. Therefore, the terminal 1 (or a user of the terminal 1) can decide appropriately whether communication with the Web server 2 may be started.

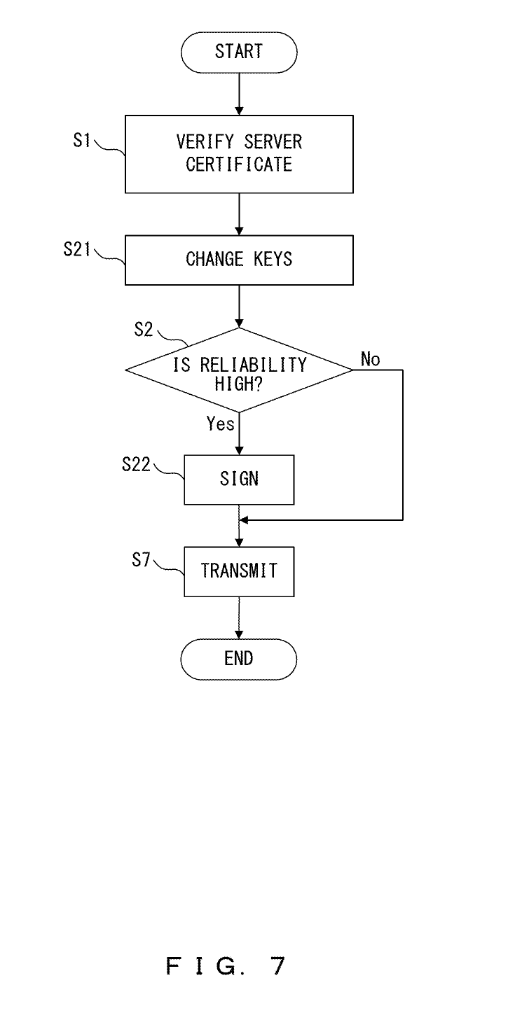

FIG. 7 is a flowchart illustrating a variation of the communication method according to the embodiment. S1 and S2 of FIG. 7 are substantially the same as those of FIG. 5, and descriptions thereof are omitted.

In the example illustrated in FIG. 7, a proxy certificate is generated from the received server certificate. At this time, the certificate issuance unit 16 replaces the “public key” that has been set in the server certificate with a public key used in an organization. In addition, the certificate issuance unit 16 may change the “issuer”.

When it is decided that the server certificate has a high reliability (S2: Yes), the signature unit 18 generates proxy signature data using a private key generated by the private certificate authority 3a in the SSL proxy server 3 in S22. Then, the SSL proxy server 3 transmits, to the terminal 1, the proxy certificate and the generated proxy signature data. In other words, when the SSL proxy server 3 decides that the server certificate has a high reliability, a certificate that has been re-signed by the SSL proxy server 3 is transmitted to the terminal 1.

In this case, the terminal 1 can verify the proxy certificate by decrypting the proxy signature data using a public key corresponding to the private key generated by the private certificate authority 3a. In other words, when the terminal 1 verifies the proxy certificate, the terminal 1 can confirm that the Web server 2 has been authenticated by a server certificate having a high reliability.

On the other hand, when it is decided that the server certificate has a low reliability (S2: No), the process of S22 is skipped. In other words, in the SSL proxy server 3, the proxy certificate is not re-signed. In this case, the SSL proxy server 3 transmits, to the terminal 1, for example, the proxy certificate and server signature data that has been given to the server certificate. Alternatively, the SSL proxy server 3 does not transmit the signature data, but transmits the proxy certificate to the terminal 1.

In this case, the terminal 1 fails to verify the proxy certificate. In other words, when the terminal 1 receives the proxy certificate and the server signature data, the hash value of the proxy certificate does not match the decryption result of the server signature data. In addition, when signature data has not been given to the proxy certificate, matching process is not performed. Therefore, when the proxy certificate fails to be verified, the terminal 1 can confirm that the Web server 2 has not been authenticated by a server certificate having a high reliability.

Further, the SSL proxy server 3 may calculate fingerprint information of a received server certificate, and may additionally write the calculation result in a specified region of the proxy certificate. In this case, the SSL proxy server 3 changes keys and performs re-signing similarly to the example above, and transmits a re-signed certificate to the terminal 1. Here, it is assumed that the terminal 1 can obtain fingerprint information that is disclosed, for example, by a certificate authority that is an issuer of the server certificate. As a result of this, the terminal 1 can confirm the fingerprint information of the server certificate by comparing the fingerprint information in the re-signed certificate received from the SSL proxy server 3 with the fingerprint information obtained from the certificate authority.

<Hardware Configuration of Relay Device (SSL Proxy Server 3)>

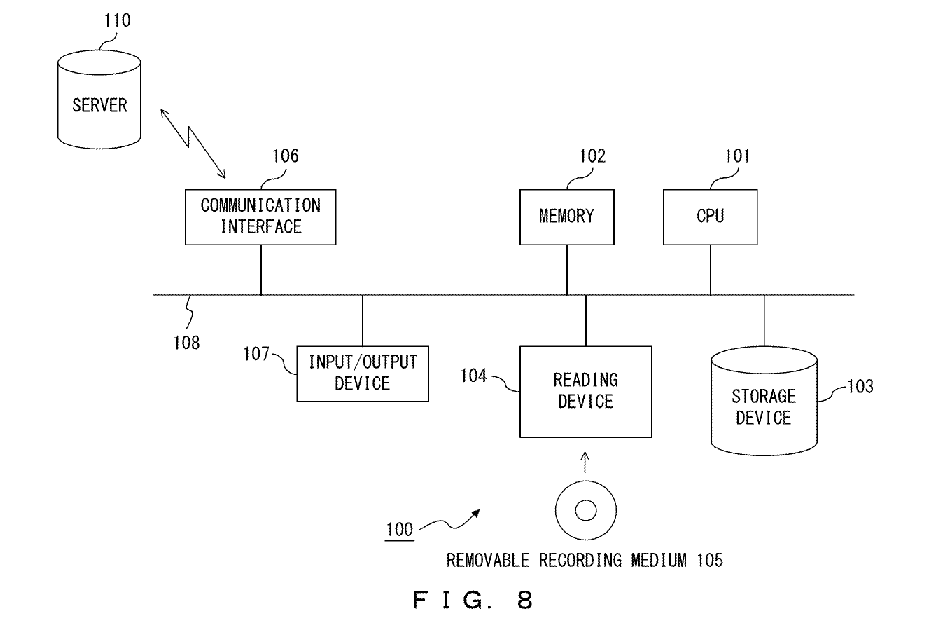

FIG. 8 illustrates a hardware configuration of a relay device according to the embodiment. The relay device includes a computer system 100 illustrated in FIG. 8. The computer system 100 includes a CPU 101, a memory 102, a storage device 103, a reading device 104, a communication interface 106, and an input/output device 107. The CPU 101, the memory 102, the storage device 103, the reading device 104, the communication interface 106, and the input/output device 107 are connected to each other, for example, via a bus 108.

The CPU 101 can provide functions of the certificate verification unit 13, the certificate issuance unit 16, and the signature unit 18 by executing a communication program using the memory 102. In other words, the CPU 101 can execute, for example, a communication program that describes processes of the flowchart illustrated in FIG. 5, FIG. 6, or FIG. 7.

The memory 102 is, for example, a semiconductor memory, and is configured to include a RAM region and a ROM region. The storage device 103 is, for example, a hard disk device, and stores the communication program above. The storage device 103 may be a semiconductor memory such as a flash memory. In addition, the storage device 103 may be an external recording device.

The reading device 104 accesses a removable recording medium 105 in response to an instruction from the CPU 101. The removable recording medium 105 is realized, for example, by a semiconductor device (e.g., a USB memory), a medium that information is input into or output from by a magnetic effect (e.g., a magnetic disk), a medium that information is input into or output from by an optical effect (e.g., a CD-ROM or a DVD), or the like. The communication interface 106 can transmit and receive data via a network in response to an instruction from the CPU 101. The input/output device 107 includes a device that receives an instruction from a user, a device that outputs information indicating a state of communication processing, or the like.

A communication program according to the embodiment is provided to the communication system 100 in the following forms, for example.

(1) The communication program has been installed beforehand on the storage device 103.

(2) The communication program is provided by the removable recording medium 105.

(3) The communication program is provided from a program server 110.

### Additional Embodiment 1

A relay device (proxy server) may transfer, to a terminal, a server certificate that is received from a Web server, without verifying the reliability of the server certificate. In this case, the reliability of the server certificate is verified in the terminal. When it is decided that the server certificate has a high reliability, the terminal reports the decision result to the relay device. Then, the relay device issues a re-signed certificate, and transmits the re-signed certificate to the terminal.

According to this method, even if the server certificate has a low reliability, communication between the terminal and the Web server is not interrupted by the relay device. However, this method needs a procedure of making, from the relay device to the terminal, a request for verifying the reliability of the server certificate, and this does not conform to the SSL protocol. In other words, the terminal may not be capable of performing SSL communication using general software such as a Web browser. Therefore, this method is lower in convenience than the embodiment illustrated in FIGS. 1-7.

### Additional Embodiment 2

A relay device verifies a server certificate received from a Web server. When the server certificate has a high reliability, the relay device transmits, to a terminal, a certificate on which a key change and re-signature have been performed. On the other hand, when the server certificate has a low reliability, the relay device transmits, to the terminal, a message indicating that SSL communication is not performed.

This method may conform to the SSL protocol. In addition, the terminal can recognize that the server certificate that authenticates the Web server has a low reliability. However, in this method, when the server certificate has a low reliability, the terminal does not receive a certificate (either of the server certificate and the proxy certificate). Therefore, in this method, it is difficult to answer a request such as “SSL communication is wished to be performed even if the server certificate has a low reliability”. Thus, this method is lower in convenience than the embodiment illustrated in FIGS. 1-7.

### Additional Embodiment 3

A relay device verifies a server certificate received from a Web server. In addition, the relay device can establish SSL sessions between the Web server and the relay device and between the relay device and a terminal. Then, the relay device reports a verification result of the server certificate to the terminal via the SSL sessions. At this time, the verification result of the server certificate is written, for example, to an HTML header, and is transmitted to the terminal.

This method may also conform to the SSL protocol. In addition, the terminal can recognize that the server certificate has a low reliability. However, in this method, communication is limited to HTTP over SSL, and therefore it is difficult to apply this method to SSL communication other than HTTP (e.g., SSL-VPN). In addition, in order to display, on the terminal, the verification result written to the HTML header, a dedicated browser needs to be installed in the terminal. Therefore, this method is lower in convenience than the embodiment illustrated in FIGS. 1-7.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication method used in a relay device that is provided between a terminal and a server, the communication method comprising:
verifying a reliability of a server certificate that is transmitted from the server for cryptographic communication between the server and the relay device using a processor;
issuing a proxy certificate based on the reliability of the server certificate for cryptographic communication between the relay device and the terminal using the processor; and
transmitting the proxy certificate to the terminal.

2. The communication method according to claim 1, further comprising:
issuing a first proxy certificate including first information using the processor, and transmitting the first proxy certificate to the terminal, when the server certificate satisfies a specified condition; and
issuing a second proxy certificate including second information that is different from the first information using the processor, and transmitting the second proxy certificate to the terminal, when the server certificate does not satisfy the condition.

3. The communication method according to claim 2, wherein
the server certificate includes certificate authority identification information indicating a certificate authority that authenticates the server,
the first proxy certificate is issued by replacing the certificate authority identification information included in the server certificate with the first information, when the server certificate satisfies the condition, and
the second proxy certificate is issued by replacing the certificate authority identification information included in the server certificate with the second information, when the server certificate does not satisfy the condition.

4. The communication method according to claim 2, further comprising:
encrypting the first proxy certificate using a first signature private key to generate first proxy signature data using the processor, and transmitting the first proxy signature data to the terminal, when the server certificate satisfies the condition; and
encrypting the second proxy certificate using a second signature private key that is different from the first signature private key to generate second proxy signature data using the processor, and transmitting the second proxy signature data to the terminal, when the server certificate does not satisfy the condition.

5. The communication method according to claim 2, further comprising:
deciding whether the server certificate satisfies respective plural specified conditions using the processor, wherein
when the server certificate does not satisfy at least one of the plural specified conditions, the second proxy certificate includes information corresponding to the condition that the server certificate does not satisfy.

6. The communication method according to claim 2, further comprising:
deciding whether the server certificate satisfies respective plural specified conditions using the processor; and
encrypting the second proxy certificate using a private key corresponding to the condition that the server certificate does not satisfy to generate second proxy signature data using the processor, and transmitting the second proxy signature data to the terminal, when the server certificate does not satisfy at least one of the plural specified conditions.

7. A communication method used in a relay device that is provided between a terminal and a server, the communication method comprising:
verifying a reliability of a server certificate that is transmitted from the server for cryptographic communication between the server and the relay device using a processor;
replacing a server public key included in the server certificate with a proxy public key corresponding to a proxy private key that is used by the relay device to issue a proxy certificate using the processor, generating proxy signature data based on contents of the proxy certificate using the processor, and transmitting the proxy certificate and the proxy signature data to the terminal, when the server certificate satisfies a specified condition; and
issuing the proxy certificate using the processor, and transmitting the proxy certificate and server signature data that has been given to the server certificate to the terminal, when the server certificate does not satisfy the specified condition.

8. A non-transitory computer-readable recording medium having stored therein a program for causing a computer to execute a communication process, the communication process being executed in a relay device provided between a terminal and a server, the communication process comprising:
verifying a reliability of a server certificate that is transmitted from the server for cryptographic communication between the server and the relay device;
issuing a proxy certificate based on the reliability of the server certificate for cryptographic communication between the relay device and the terminal; and
transmitting the proxy certificate to the terminal.

9. A relay device provided between a terminal and a server, the relay device comprising:
a certificate verification unit configured to verify a reliability of a server certificate that is transmitted from the server for cryptographic communication between the server and the relay device;
a certificate issuance unit configured to issue a proxy certificate based on the reliability of the server certificate for cryptographic communication between the relay device and the terminal; and
a transmitter configured to transmit the proxy certificate to the terminal.

10. A relay device provided between a terminal and a server, the relay device comprising:
a processor configured to perform a communication process, and the communication process including:
verifying a reliability of a server certificate that is transmitted from the server for cryptographic communication between the server and the relay device;
issuing a proxy certificate based on the reliability of the server certificate for cryptographic communication between the relay device and the terminal; and
transmitting the proxy certificate to the terminal.
